(19) United States
(12) Patent Application Publication
(10) Pub. No.: US 2017/0053353 A1
(43) Pub. Date: Feb. 23, 2017

(54) Personal Financial Management System and Method

(71) Applicant: Neill Groom, Shrewsbury, NJ (US)

(72) Inventor: Neill Groom, Shrewsbury, NJ (US)

(21) Appl. No.: 15/232,681

(22) Filed: Aug. 9, 2016

Related U.S. Application Data
(60) Provisional application No. 62/205,963, filed on Aug. 17, 2015.

(51) Int. Cl. G06Q 40/06; G06F 17/30

(52) U.S. Cl. CPC G06Q 40/06; G06F 17/30958; G06F 17/3053; G06F 17/30867

(57) ABSTRACT

Disclosed is a system and method for automatically allocating funds to various accounts and saving money. Some embodiments of the system include an application that is used to collect information about a user's financial accounts and calculate allocation amounts in order to allocate money in a systematic manner and maximize savings. Some embodiments of the method include categorizing the user's financial accounts by type, ranking the accounts by interest rates, payments, or balances, and allocating funds to each account in order. Additionally, some embodiments of the method include calculating the user's future net worth and comparing the user's financial status to his or her peers' financial status.

### CROSS-REFERENCE TO RELATED APPLICATIONS

This application claims the benefit of U.S. Provisional Patent Application No. 62/205,963, filed Aug. 17, 2015, which is hereby incorporated by reference in its entirety.

### FIELD OF THE INVENTION

The present invention generally relates to a system and method for banking. More particularly, the present invention is directed to automatically allocating savings by ranking accounts and calculating optimal amounts for allocation to each of the accounts.

### BACKGROUND OF THE INVENTION

When managing money, saving is the key to obtaining financial independence and building wealth. However, setting aside an optimum amount of savings while accounting for various and numeral expenses can be a difficult and complex task for many individuals.

Although many individuals obtain advice from financial planners and accountants, asset management software and similar financial planning tools have become increasingly popular over the years. While these types of tools generally allow users to set financial goals, they often do not provide a detailed tracking mechanism that is easily understandable and operable. In this way, existing tools can lack the proper guidance that the users need in reaching their goals in an accountable manner. In this regard, the invention described herein addresses this problem.

### SUMMARY OF THE INVENTION

In view of the disadvantages inherent in the known types of systems and methods for personal financial planning now present in the prior art, the present invention provides an improved system for automatically allocating savings and method of use thereof.

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Some embodiments of the system include a memory unit having instructions stored thereon, and a processor operatively connected to the memory unit, wherein the processor is configured to execute the instructions, resulting in an application that is configured to: collect all financial account information associated with a user; identify an account type for each of the user's financial accounts, and then categorize the user's accounts by type; determine interest rates for each of the accounts; rank each account in a descending (i.e., highest interest rate to the lowest interest rate) order, via a ranking module, based upon the interest rate associated with each account; re-rank two or more accounts having equal interest rates, via the ranking module; calculate a monthly contribution amount for each account, via a contribution calculator; determining amounts to actually contribute to each account via a comparison module; and allocate contributions to each account in a systematic manner, via an allocation module, and determine savings.

In some embodiments, the system includes: a processor and a web portal executing on the processor, the web portal having the functionality to receive a user's financial account information, demographic information, and other financial information (e.g., income, taxes, tax filing status, etc.) relating to the user via a user interface; a ranking module for identifying each of financial accounts held by the user and analyzing the interest rates, balances, or payment requirements associated with these accounts in order to rank the accounts and establish a ranking order; a contribution calculator for calculating monthly contribution amount for each of these accounts and a monthly savings amount based upon user inputs for savings rate, income, and taxes; and an allocation module for allocating monthly contribution amount for each of these accounts, wherein when an account reaches its maximum monthly contribution amount, the allocation module stops allocating money to that account and starts allocating funds to the next ranked account, and so on until some or all of the accounts have reached its maximum monthly contribution amount.

In some embodiments, a computer-implemented method is provided for displaying a user's financial accounts in buckets via a user interface. The accounts are categorized based on type, such as retirement, savings, debt account, investment, and the like. Each bucket corresponds the account type. In this regard, the system comprises a bucket for savings, retirement, debt, investment, college savings, mortgage, and the like. Each of the accounts within the buckets is assigned an interest rate, wherein the interest rate may be automatically assigned by default. Thereafter, the accounts are ranked based on the interest rate. If two or more accounts comprise the same interest rate, then the accounts are re-ranked based on its type and other factors. Once the accounts are ranked, a monthly contribution amount for each account is calculated and allocated to each respective account in a descending order. The monthly contribution account and the allocated amount for each account within each bucket are displayed on the respective bucket. In this way, the user interface enables a user to easily visualize monthly contributions in an organized manner for a number of accounts.

In some embodiments, the system includes a processor and a web portal executing on the processor, the web portal having the functionality to: estimating a user's future net worth by adding all of the current funds in each of the user's accounts and adding all of the projected funds in each of the user's accounts; compare a user's financial portfolio with that of his or her peers; and present the user's present and future net worth as well as the user's assets and liabilities in a graphical representation. It is contemplated that peer groups are identified using a variety of factors including age, income, location, number of dependents, home ownership status, and the like. In this way, the user can determine whether or not he or she is making the progress that he or she is expected to or recommended to make, particularly in terms of retirement.

It is therefore an objective of the present system and method to allocate users' funds for eliminating debt while maximizing savings.

It is another objective of the present system and method to provide a user interface for visualizing monthly contribution amounts and savings in virtual buckets corresponding to different types of accounts held by a user.

It is another objective of the present system and method to calculate a user's net worth and track the user's financial performances relative to the user's peers.

In the light of the foregoing, these and other objectives are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 is a general architecture of an exemplary embodiment of the present system.

FIG. 2A is a flow diagram of the overview process steps for utilizing the present system.

FIGS. 2B and 2C show exemplary embodiments of the user interface of the present system.

FIGS. 3A and 3B show exemplary method steps for ranking accounts.

FIGS. 4A and 4B show exemplary method steps for comparing values.

FIGS. 5A through 5F show exemplary method steps for saving allocation.

### DETAILED DESCRIPTION OF THE INVENTION

The present invention is directed towards a system and method of allocating savings. For purposes of clarity, and not by way of limitation, illustrative views of the present system and method are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

It is to be appreciated that determinations or inferences referenced throughout the subject specification can be practiced through the use of artificial intelligence techniques. In this regard, some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Discussions herein utilizing terms such as, for example, “processing,” “computing,” “calculating,” “determining,” “establishing,” “identifying,” “analyzing,” “checking,” or the like, may refer to operations(s) and/or process(es) of a computer, a computing platform, a computing system, or other electronic computing device, that manipulate and/or transfer data represented as physical (e.g., electronic) quantities within the computer's registers and/or memories into other data similarly represented as physical quantities within the computer's registers and/or memories or other information storage medium that may store instructions to perform operations and/or processes.

Some embodiments of the present invention may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a personal computer (PC), a desktop computer, a mobile computer, a laptop, a tablet computer, a server computer, a handheld device, a personal digital assistant (PDA), a wireless communication device, a smart phone, a non-portable device, a wireless access point (AP), a wired or wireless router, a wired or wireless modem, a wired or wireless network, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN), or networks operating in accordance with existing and/or future versions and/or derivatives of long term evolution (LTE), a device which incorporates a global positioning system (GPS) receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, or the like.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” unless specified otherwise or clear from context to be directed to a singular form.

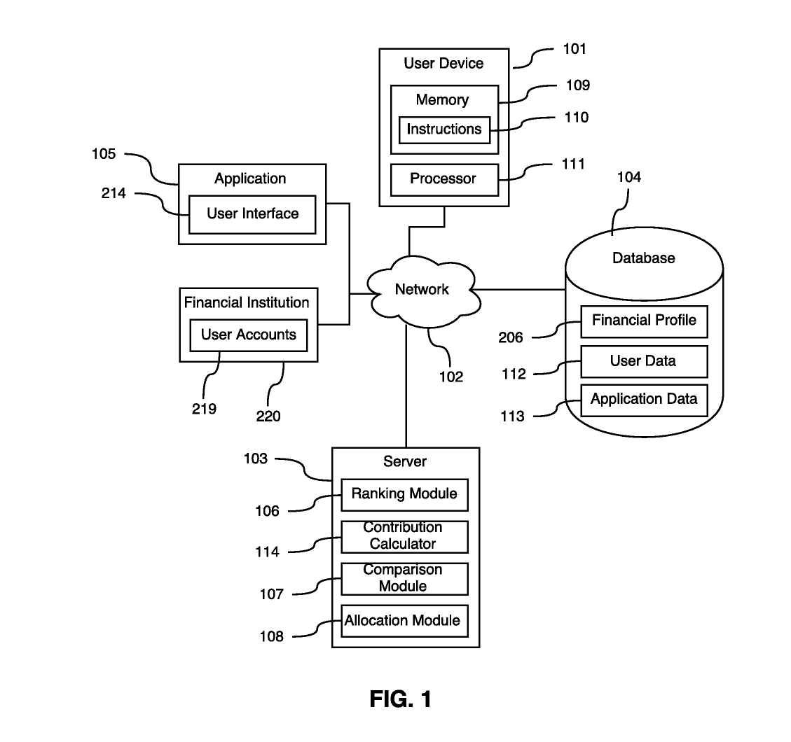

Referring now to FIG. 1, there is shown a view of the exemplary architecture of the present system in a block diagram format. In the illustrated embodiment, the system comprises at least one user device 101 that is operated via an end user, wherein the device 101 is in communicably connected with a network 102 (e.g., LAN, the Internet), the network 102 in further connection to at least one server 103. In some embodiments, the system further comprises additional computer systems such as a peer machine in a peer-to-peer (or distributed) network environment.

Each of the user device 101 and the server 103 comprises various types of computer systems, including a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine.

An exemplary computer system includes a processor 111 (e.g., a central processing unit (CPU), a graphics processing unit (GPU), or both) communicably coupled to a memory unit 109 (e.g., a main memory unit, a static memory unit, or both) via, for example, a BUS. The computer system may further include a display device (e.g., a liquid crystal display (LCD) or a cathode ray tube (CRT)), an alphanumeric input device (e.g., a keyboard), a user interface (UI) navigation device (e.g., a mouse), a disk drive unit, a signal generation device (e.g., a speaker), and a network interface device. The computer system may also include other types of input devices such as an environmental input device that may provide a number of inputs describing the environment in which the computer system or another device exists, including, but not limited to, a camera and an audio sensor (e.g., a microphone).

One or more sets of instructions 110 reside, completely or at least partially, within the main memory unit 109 and/or within the processor 111 during execution thereof by the computer system. In this regard, the main memory unit 109 and the processor 111 constitute machine-readable media, depending upon embodiment. The disk drive unit also includes a machine-readable medium on which may be stored one or more sets of data structures and instructions (e.g., software) embodying or utilized by any one or more of the methodologies or functions described herein.

The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 110 may further be transmitted or received over a computer network 102 (FIG. 1) using a transmission medium. The instructions 110 may be transmitted using the network interface device and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

The instructions 110, when executed by the processor 111, result in an application 105, which comprises a website, a web portal, a web application, a mobile application, a plug-in, or other types of non-downloadable and/or downloadable software. The application 105 comprises a user interface 214, which enables a user to interact with one or more components of the present system.

In some embodiments, the user interface 214 is configured for creating a user account and/or providing login to returning users with existing accounts. When creating an account, the user is prompted to provide basic demographic information that would help identify the user's tax bracket, such as income information, marital status (or tax filing status), and savings rate. Additionally, the user may be prompted to provide additional information that would allow the web application to provide tailored financial recommendation.

The application 105, via the user interface 214, requests the user to input user's financial account information 219 such as account numbers associated with each of the user's financial accounts and financial institution name for each of the user's bank accounts, loan accounts, investment accounts, retirement accounts, credit card accounts, savings accounts or any combination thereof. The request involves accessing and retrieving data associated with the user's financial account information 219 from one or more financial institutions 220. More specifically, upon receiving account number, financial institution name, and/or other identifying information from the user, the server 103 initially establishes a connection to servers operated or controlled by the financial institutions 220. After retrieving data correlating to the user's financial accounts 219, all of the user's financial information, such as assets and liabilities are connected and made centrally accessible via the application 105. In this way, the user interface 214 provides an overview of the user's total amount of assets and liabilities.

The application 105 is managed by the server 103, which comprises a ranking module 106, a contribution calculator 114, a comparison module 107, and an allocation module 108. The application 105 is configured to collect all account information 219 and balances from account connection API. Each account is then categorized by type via the ranking module 106. Without limitation, one embodiment of the ranking module 106 is configured to categorize accounts as a retirement account, a college savings account, a debt account, an investment account, and a savings account. Each of the categories corresponds to a virtual bucket that is displayed on the user interface 214.

The ranking module 106 further identifies interest rates for each of the categorized accounts. The application 105 automatically assigns default interest rates to certain accounts. In this way, the application 105 automatically ranks each account without requiring users to take further actions. It is noted, however, that users can adjust interest rates or manually input interest rates for one or more accounts, depending upon embodiment.

Two interest rates are assigned to retirement accounts with an employer match. Similarly, debt accounts are given two interest rates: a minimum payment interest rate; and a stated account interest rate, which is the interest rate on the given account. The minimum payments are given the highest priority so as to prevent the user from accruing and paying additional interest. Thus, the minimum payment interest rate is ranked before the stated account interest for debt accounts.

Once the accounts are given interest rates, the ranking module 106 orders the accounts in a descending order based upon the interest rates (i.e., highest interest rate to the lowest interest rate) to establish a ranking order. Accounts with multiple interest rates, such as retirement accounts with an employer match, are ranked once for each interest rate.

If two or more accounts have the same interest rate, the ranking module 106 ranks the debt account first, wherein the debt account comprises accounts where money is due, such as credit card accounts and loan accounts. Thereafter, the ranking module 106 ranks the accounts in a descending order by minimum payment amount (i.e., highest minimum payment to the lowest minimum payment) and in an ascending order by outstanding balance (i.e., lowest balance to the highest balance).

The contribution calculator 114 is configured to calculate the user's annual savings amount, monthly savings amount, and monthly contribution amounts for each of the user's ranked accounts based on the user's income, savings goal, and tax implications. The comparison module 107 analyzes the calculated monthly contribution amounts to determine how much to actually allocate to each of the user's ranked accounts. Once actual allocation amounts are determined, the allocation module 108 allocates the monthly contribution amounts based on the ranking order.

The system further comprises at least one database 104 coupled to the one or more servers 103, wherein the database 104 contains users' financial profile 206 (e.g., the user's financial account information 219), user data 112 (e.g., user name, password, user's demographic information) correlating to each user account, and any other application data 113 (e.g., application logic, analytics information, cookies and online tracking tools, log file information, device identifiers, location information, etc.)

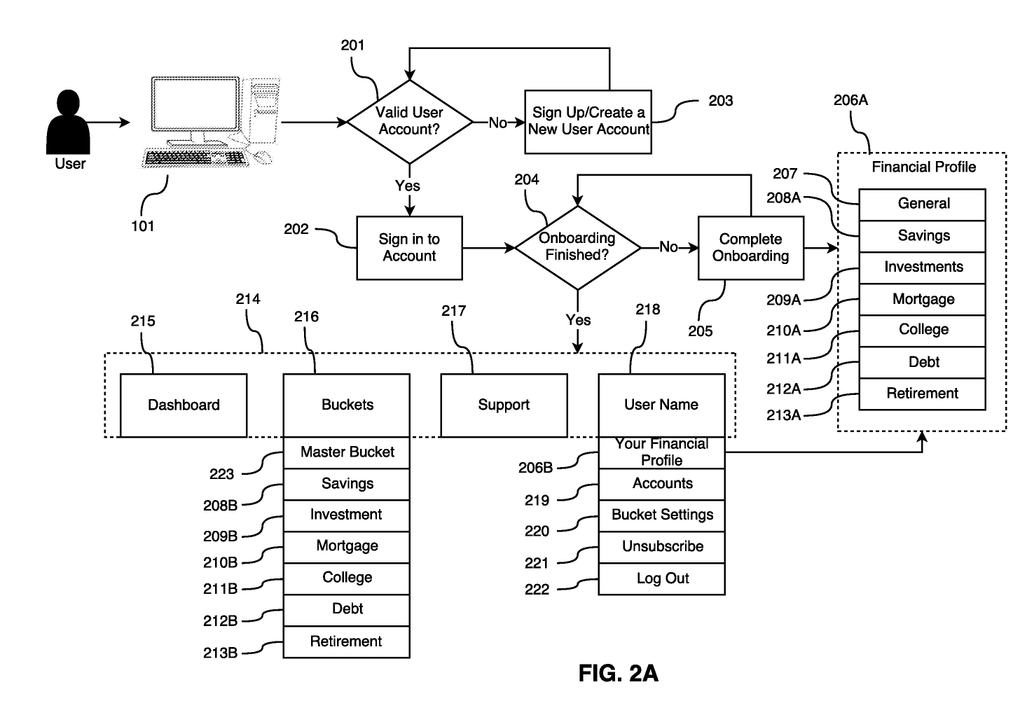

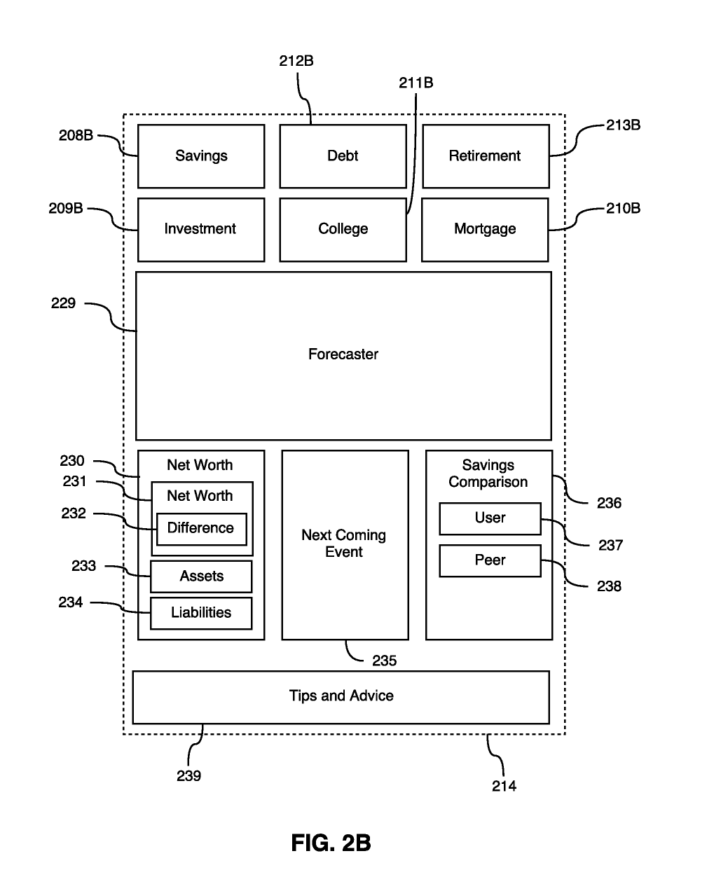

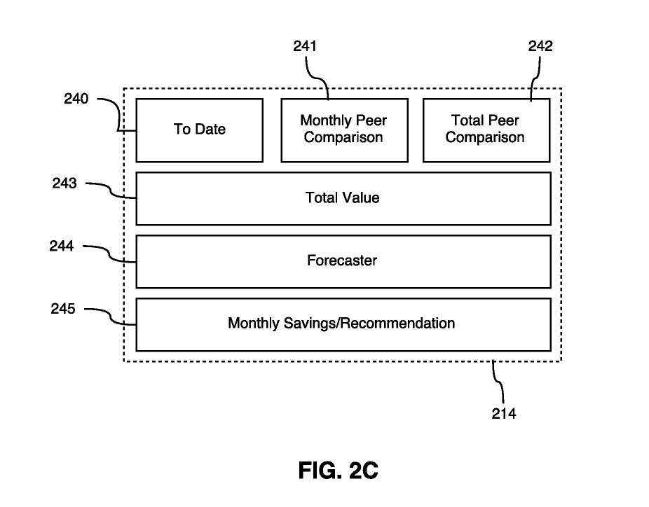

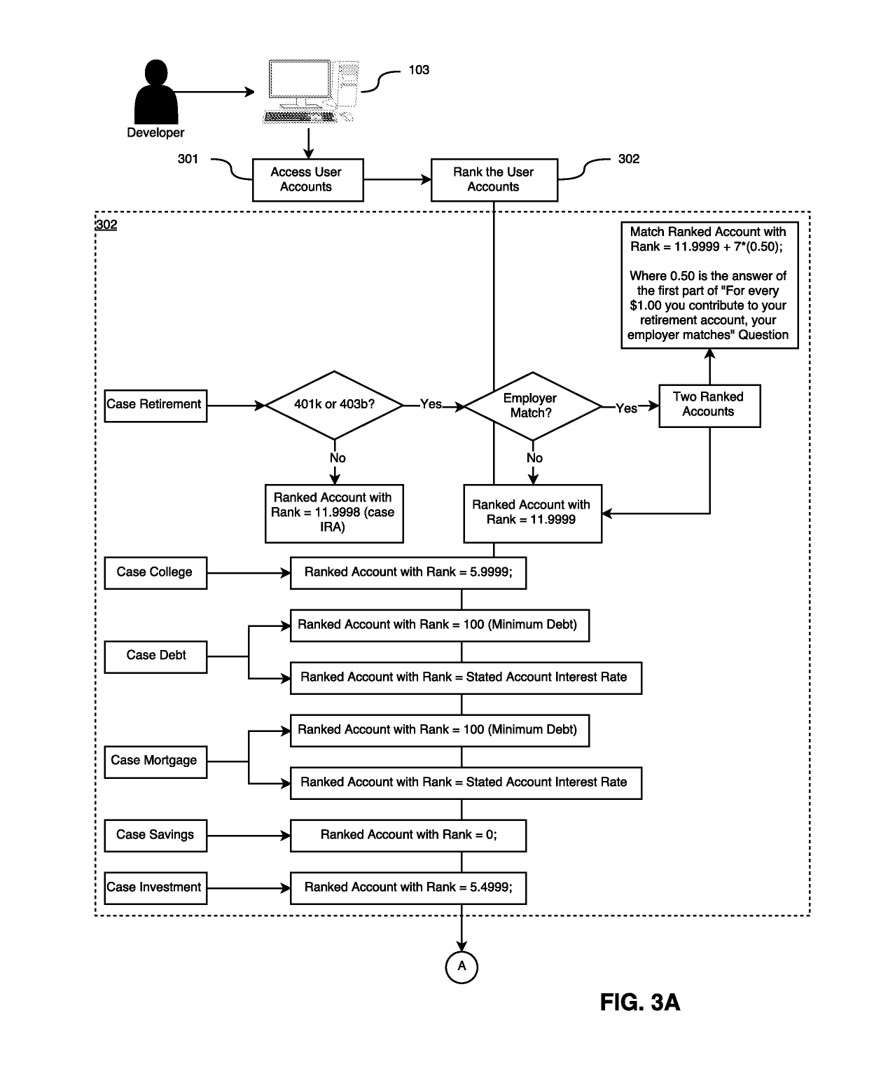

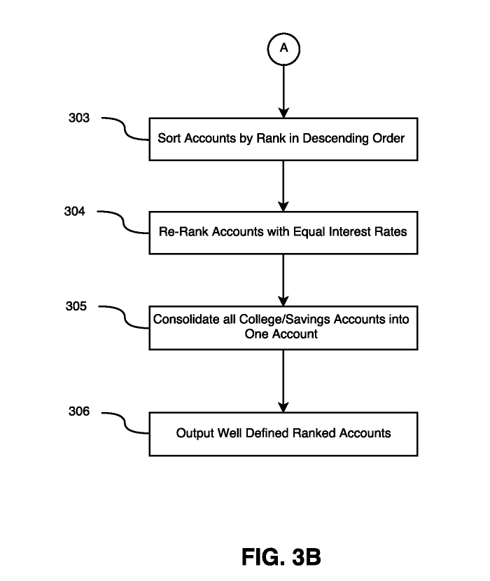

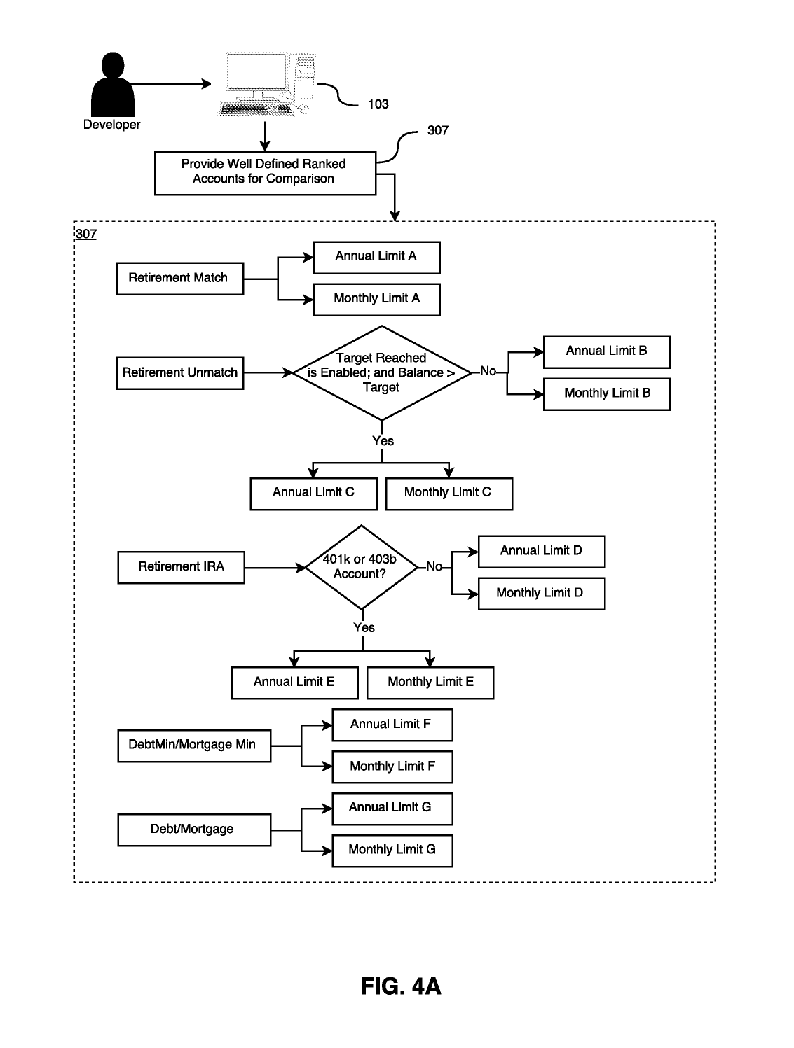

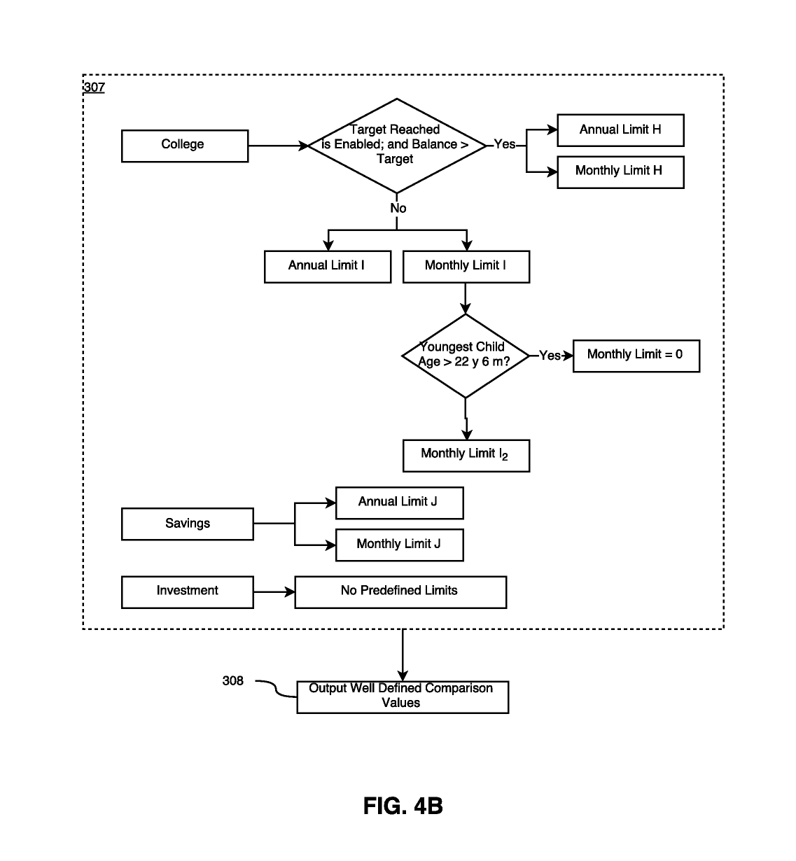

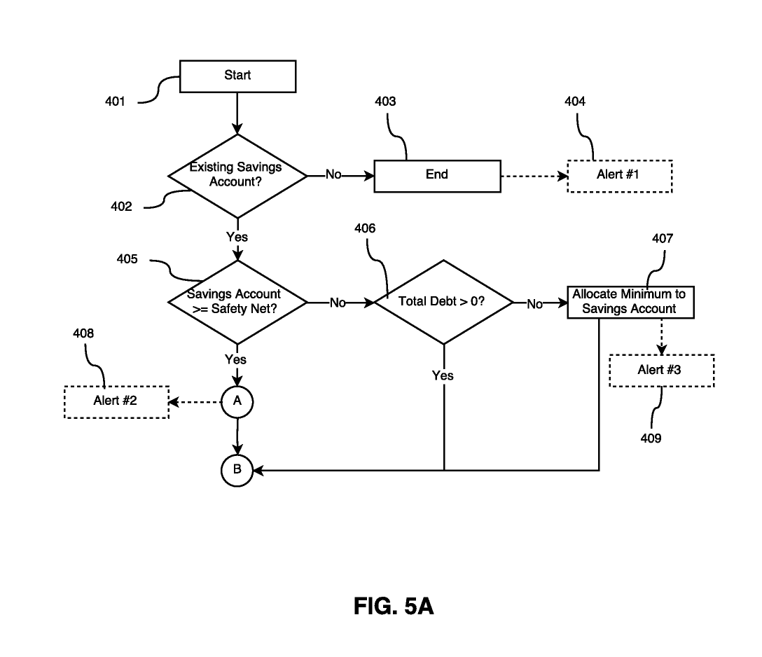

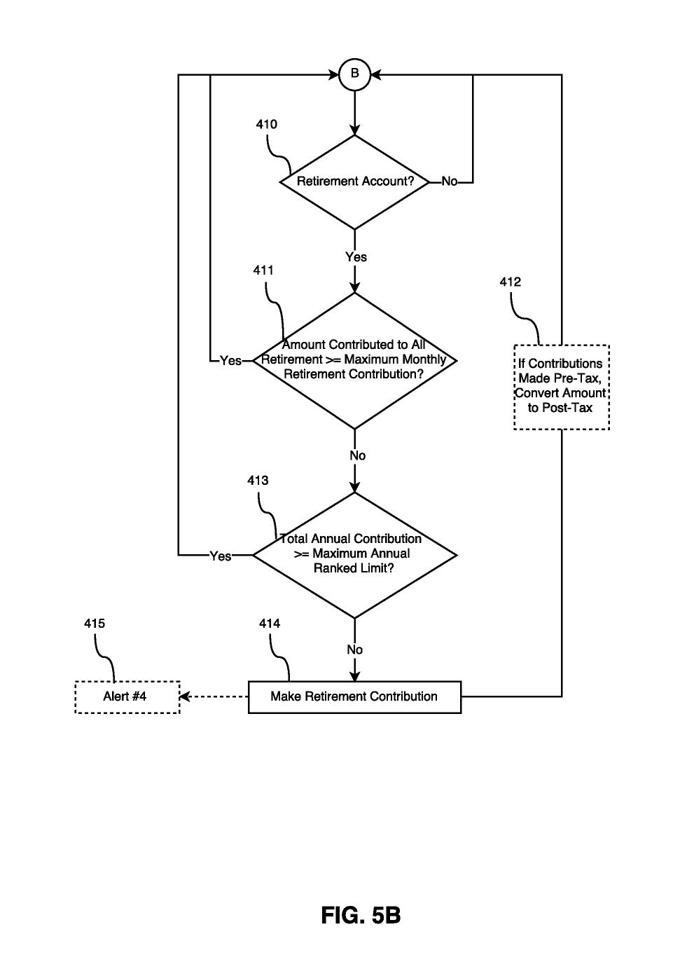

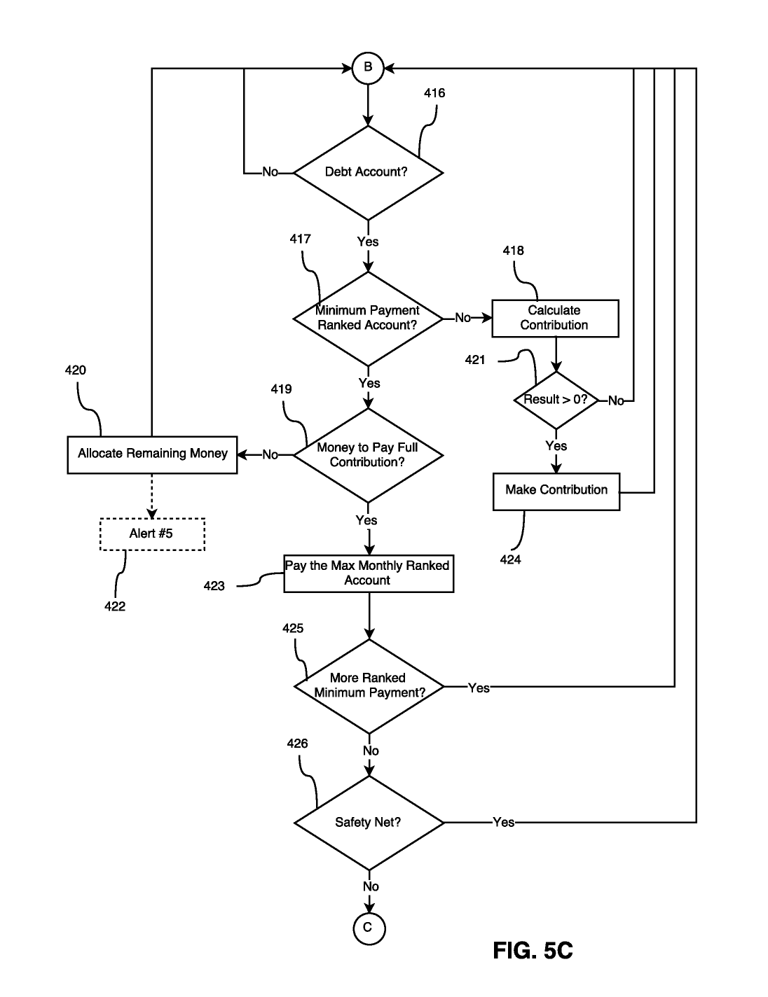

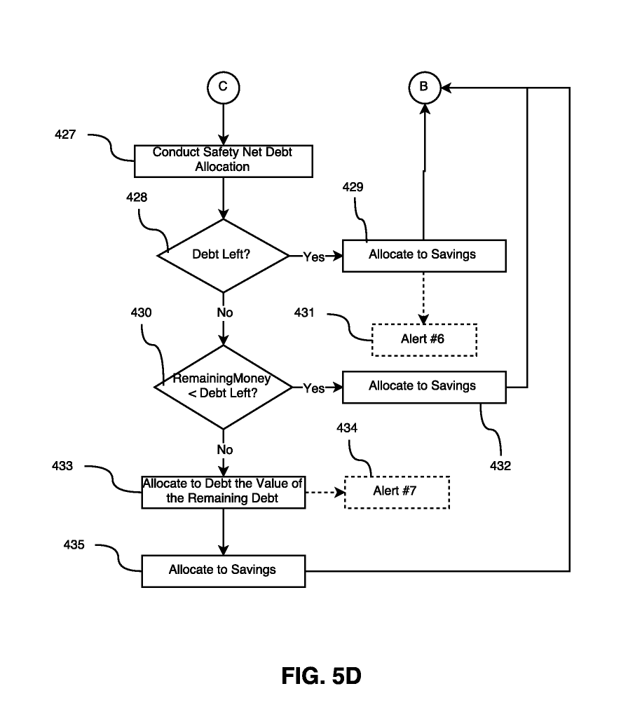

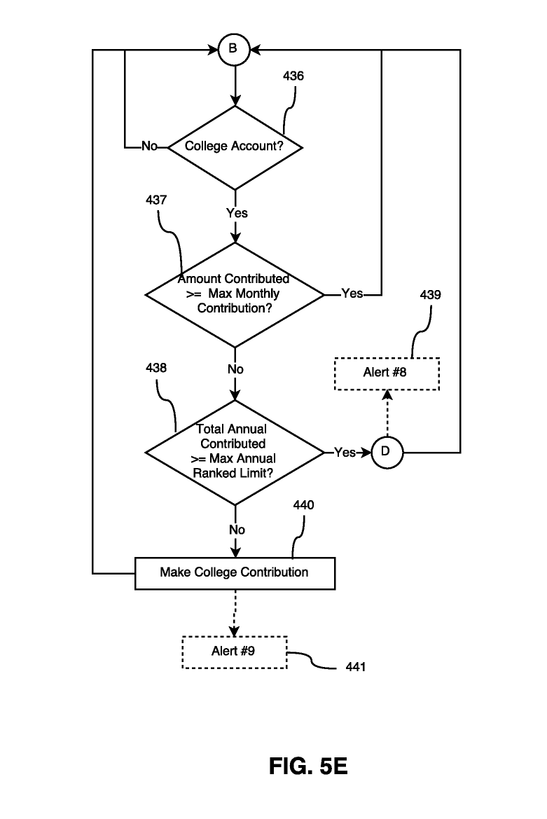

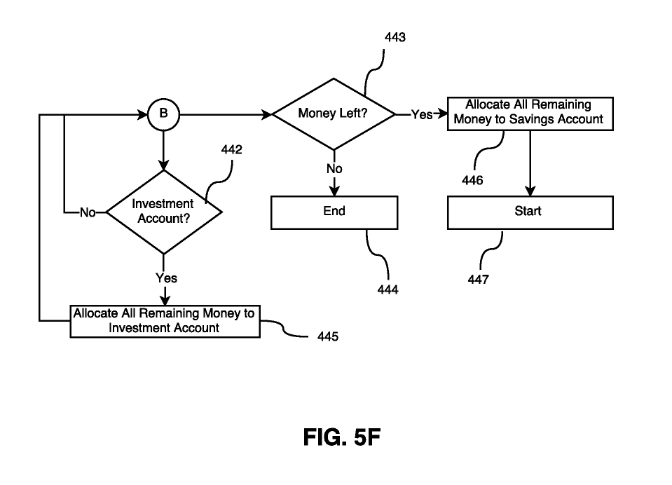

Reference is also made to FIGS. 2A through 5F, which schematically illustrate exemplary methods and user interface of the present invention. In some embodiments, one or more operations of FIGS. 2A and 3A through 5F may be performed by one or more elements of the system shown in FIG. 1 (e.g., user devices, server, etc.).

FIG. 2A is a flow diagram of the overview process steps for utilizing the present system. The user can access the application 105 (FIG. 1), for example, by using a web browser on the user device 101, and log onto his or her account. If the user provides a valid user account 201, the user is signed into his or her account 202. If the user does not provide valid user account information 201, the user is requested to sign up and create a new user account 203.

Once the user is signed onto his or her account, the application 105 (FIG. 1) confirms whether onboarding is completed 204. As used herein, onboarding primarily refers to collecting user data from the user with regards to the user's financial profile 206A and related information thereto. If the onboarding process is completed 205, the user can access the dashboard 215, buckets 216, customer support 217, and user profile 218 (e.g., displayed as a link labeled as the user's name) via the user interface 214 (FIG. 1).

From the home page or the dashboard 215, the user can access the buckets 216, which include each of the user's external financial accounts. In the illustrated embodiment, the buckets 216 comprise a bucket for savings accounts 208B, investment accounts 209B, mortgage accounts 210B, college savings accounts 211B, debt accounts 212B, retirement accounts 213B, and a master bucket 223.

The user can also access his or her profile 218 from the home page or the dashboard 215. The profile 218 provides an overview of the user's financial profile 206B, which is derived from external sources (e.g., financial institutions). The user's financial profile 206B includes information relating to the user's savings accounts 208A, investment accounts 209A, mortgage accounts 210A, college savings accounts 211A, debt accounts 212A, retirement accounts 213, and general information 207 relating thereto. The user's financial profile 206B substantially mirror each of the buckets 216 described herein.

Additionally, the user can manage and view status updates of his or her accounts 219. Non-limiting examples include the user's progress towards a financial goal, the user's portfolio status in comparison to other users' portfolios, and/or projected net worth of the user. The user can provide additional information about his or her financial status via a questionnaire from the profile to update the account settings and bucket settings 220, or to further tailor financial recommendation provided to him or her. Furthermore, the user can unsubscribe to the application via the unsubscribe button 221, and a log out via the log out button 222.

Referring now to FIG. 2B, the user interface 214 of the dashboard comprises a plurality of buckets, which comprise a savings bucket 208B, a debt bucket 212B, a retirement bucket 213B, an investment bucket 209B, a college savings bucket 211B, and a mortgage/home bucket 210B. Each of the buckets is configured to display the sum of the accounts' balances within the respective buckets as well as the monthly contribution amounts and allocated amounts, if any. Additionally, the buckets are configured to display annotations, for example, whether the monthly contribution goal has been met or not met. Moreover, each of the buckets comprises an activatable link for displaying detailed information about the accounts within the buckets.

An exemplary embodiment of the detailed information is shown in FIG. 2C. Without limitation, the details for each bucket comprise recommended or allowed contribution amount and the amount contributed to each account in that bucket to date 240, monthly peer comparison 241, total peer comparison 242, total value 243 (i.e., total amount allocated to that bucket to date or within a specified period of time), allocation forecaster 244, and monthly savings/recommendation 245. The forecaster 244 preferably comprises a graphical representation of the current allocated amount and projected allocation for the respective bucket. Because many accounts are broken into two different interest rates (and therefore different account rankings), the buckets enable the user to keep track of the amount allocated to each account throughout the allocation process via the user interface.

The dashboard further comprises a master forecaster 229, wherein the forecaster 229 comprises present and future graphical representation of the user's net worth, and accounts associated with the savings bucket 208B, the debt bucket 212B, the retirement bucket 213B, the investment bucket 209B, the college savings bucket 211B, and the mortgage bucket 210B. The forecaster 229 is configured to provide an estimated value of the user's future net worth and an estimated value of an allocated amount for a bucket when pinpointed via a cursor (i.e., using a mouse) on the graph. For instance, some embodiments of the graphical representation may comprise a graph having the x-axis as years and the y-axis as amount in USD. When the cursor is positioned at an (x,y) coordinate, the forecaster 229 is configured to display the user's net worth in USD corresponding to a specific year.

The dashboard further displays the user's net worth information 230. More particularly, the dashboard displays the user's present net worth 231 and the difference 232 in the user's net worth since signing up or utilizing the application. Additionally, the user's net worth 230 can be broken down into the user's assets 233 and the user's liabilities 234, wherein the data corresponding to the user's assets 233 and liabilities 234 are derived from the financial institutions where the user's financial accounts are held.

The dashboard further displays the user's savings comparison 236, which includes the user's savings 237 and the peer savings 238. In this way, the user can determine how much he or she is saving in comparison to his or her peers. It is contemplated that data relating to peer savings or peer contribution are derived from aggregate user data, third party sources, or any combination thereof. Any upcoming events or announcements 235 pertaining to the user are also displayed on the dashboard (e.g., estimated taxes due). Finally, financial tips and advice 239 are displayed on the dashboard.

Generally, the present method comprises three main steps: ranking accounts; calculating monthly contribution amount for each of the accounts and comparing contribution amounts; and allocating funds by performing bucket logic.

Information associated with each of the user's accounts is accessed 301 by retrieving data correlating to the user's financial accounts from financial institutions. In this way, assets and liabilities are connected and made centrally accessible via the application. The user's accounts are ranked 302, via the ranking module 106 (FIG. 1). For retirement accounts, the ranking module 106 (FIG. 1) determines whether the account is a 401k account or a 403b account. If the account is not a 401k or 403b account, the account is given an interest rate of 11.9998%. If the account is a 401k or 403b account, the ranking module 106 (FIG. 1) determines whether there is an employer match. If there is no employer match, the account is assigned an interest rate of 11.9999%. If there is an employer match, the account is given a second interest rate, which is 11.9999+7*(X), wherein x is the percentage of the employer match for every one dollar. Thus, if the employer match is 50% or $0.50 for every $1.00, the second interest rate is 11.9999+7*(0.50) or 15.4999.

For college accounts, the ranking module 106 (FIG. 1) assigns an interest rate of 5.9999%. For investment accounts, the ranking module 106 (FIG. 1) assigns an interest rate of 5.4999%. The ranking module 106 (FIG. 1) assigns two interest rates to each debt account, including mortgage accounts. The first interest rate is a minimum payment interest rate of 100%, and the second interest rate is a stated account interest rate, which is the interest rate on the given account. Finally, the ranking module 106 (FIG. 1) assigns an interest rate of 0% to savings accounts.

After the interest rates are assigned to each account, the ranking module 106 (FIG. 1) sorts the accounts by interest rate in descending order 303. If two or more accounts comprise equal interest rates, the ranking module 106 (FIG. 1) re-orders those accounts 304 to establish a ranking order. More specifically, the ranking module 106 (FIG. 1) ranks the debt account first. Thereafter, the ranking module 106 (FIG. 1) consolidates all college and savings accounts into one account 305, resulting in well defined ranked accounts 306.

For each of the ranked accounts, the contribution calculator 114 (FIG. 1) determines annual and monthly contribution amounts and limit 307. Prior to allocating funds to each of the ranked accounts, the contribution calculator 114 (FIG. 1) calculates monthly savings amount based upon user inputs for savings rate, income, and taxes. The monthly after tax savings amount is the amount of money that the user can use to pay debt, save for retirement, save for college, invest, and/or save. To calculate the monthly savings, the user's annual after tax income is calculated (e.g., the user's gross annual income is multiplied by (1−(federal tax rate+state tax rate))). The contribution calculator 114 (FIG. 1) calculates the user's annual after tax income by using the savings rate in order to determine the annual savings that they are contributing to debt, retirement, college, investing, and savings. The monthly after tax savings amount is equal to the annual savings is divided by 12 months.

The contribution calculator 114 (FIG. 1) calculates the target safety net savings amount, which is approximately three months of expenses saved. In one embodiment, 75% of a user's monthly after tax wages is considered each month's expenses. The target safety net savings is equal to ((Annual Gross Salary*1−(Federal Tax Rate+State Tax Rate))/12)*2.25.

The contribution calculator 114 (FIG. 1) then calculates maximum monthly ranked account contribution. Each ranked account may have a maximum value for the amount that should be contributed each month. Without limitation, the maximum monthly contribution value may be automatically based on a minimum debt payment, retirement match dollar value, and/or statutory limits. Once a ranked account has reached the maximum monthly account contribution, the allocation module 108 (FIG. 1) is configured to automatically stop allocating money to that account and move onto the next account on the ranked list. These maximum will technically be minimums, statutory maximums, account balances, and matching minimums. For example, minimum debt payment, retirement match dollar value, account balance, and statutory limits.

Maximum annual ranked account contribution pertains to both retirement accounts and college savings accounts, for example, wherein the limit for a college savings account is $14,000 per child (Annual Limit I). Because retirement accounts have legal limits on how much can be contributed over the course of one calendar year, the comparison module 107 (FIG. 1) ensures that the allocation module 108 (FIG. 1) has not contributed more than the amount allotted. For instance, the maximum annual contribution for IRA and Roth IRA accounts are $5,500 (Annual Limit D).

The contribution calculator 114 (FIG. 1) further calculates the maximum monthly retirement contribution. Because retirement accounts will typically be the highest ranking of all of the user's accounts due to the interest rate, the comparison module 107 (FIG. 1) ensures that the allocation module 108 (FIG. 1) does not allocate the user's entire monthly savings amount to the retirement accounts. For example, the allocation module 108 (FIG. 1) is configured to allocate a maximum of 70% of the user's monthly savings amount to retirement accounts (Monthly Limit A, Monthly Limit B, Monthly Limit D). In other words, the amount contributed to retirement accounts may not exceed 70% of the user's monthly savings amount. The capped rate may be adjusted, however, depending upon embodiment.

If an employer matches a certain percentage of the user's retirement contributions, the contribution calculator 114 (FIG. 1) determines the pre-tax match and then converts this into a post-tax figure because all allocations are calculated on a post-tax basis. This value becomes the maximum monthly ranked account contribution for the matched portion of the retirement account (Monthly Limit A).

The contribution calculator 114 (FIG. 1) further calculates the maximum monthly college contribution. College savings accounts, similar to retirement accounts, comprise a legal limit. To ensure that the user does not allocate all of his or her monthly savings amount to the college savings accounts, the allocation module 108 (FIG. 1) is configured to allocate a maximum of 50% of the user's monthly savings amount to college savings accounts (Monthly Limit I₂). To determine the maximum monthly college contribution, the comparison module 107 (FIG. 1) verifies the age of the user's youngest child. If the user's youngest child is over the age of 22 years and 6 months, the maximum monthly college contribution is $0. If the user's youngest child is under the age of 22 years and 6 months, the monthly savings amount is multiplied by 0.50 (i.e., 50% of the user's monthly savings amount) (Monthly Limit I₂). The contribution amount for college savings may also be adjusted so that individual users have different predetermined thresholds. The calculated contribution amounts output well defined comparison values 308.

The present method further comprises the step of allocating the monthly after tax savings amount to the user's external financial accounts based on the accounts' ranking. During the allocation step, the application first verifies whether the user has a savings account 402. If the user does not have a savings account, the allocation step ends 403 and the application prompts 404 the user to link or re-link all of his or her external financial accounts, one of which must be a savings account. In this way, the present application requires the user to have a savings account before proceeding.

If the user has a savings account, the comparison module 107 (FIG. 1) verifies whether the saving account has funds greater than or equal to the target safety net savings 405. If the savings account has funds greater than or equal to the target safety net savings and/or an account balance of greater than zero, the comparison module 107 (FIG. 1) resumes analyzing the remaining accounts in the list. If the value of the savings account is not greater than or equal to the target safety net savings 406, then the comparison module 107 (FIG. 1) determines whether the balances for debt accounts are greater than zero. If so, the comparison module 107 (FIG. 1) resumes analyzing the remaining accounts. If the balances for debt accounts are less than or equal to zero, the allocation module 108 (FIG. 1) allocates the smaller of the 50% of the monthly savings amount or the entire target safety net savings amount 407.

The allocation module proceeds through the account list rankings in order from the highest-ranking account to the lowest ranking account. If the next highest-ranking account is a retirement account 410, the comparison module 107 (FIG. 1) determines whether the amount contributed to the user's retirement accounts is greater than or equal to the maximum monthly retirement contribution 411. If the user has met the maximum monthly retirement contribution amount, the allocation module proceeds to the next ranked account. If the user has not met the maximum monthly retirement contribution amount, the comparison module 107 (FIG. 1) determines whether the total annual amount contributed to the user's retirement account is greater than or equal to the maximum annual ranked account contribution limit 413. If so, the allocation module proceeds to the next ranked account. If the user has not met the maximum annual ranked account contribution limit, the allocation module contributes 414 the smallest amount of the following: the maximum monthly retirement contribution; the maximum annual ranked contribution limit; the maximum monthly ranked account contribution; or the remaining amount of monthly savings amount.

If the maximum annual ranked contribution limit is the smallest amount, the user is alerted 415, for example, via a messaging feature on the user interface. If the maximum annual ranked contribution limit is a matched retirement account, the user is also notified 415 that they have reached the amount needed to receive a full employer match. If the maximum annual ranked contribution limit is not a matched retirement account, the user is notified 415 that the recommended contribution amount is lowered because the user has reached the annual maximum for retirement contributions. If contributions are made using a pre-tax amount, then the contribution calculator 114 (FIG. 1) converts this amount to a post-tax amount 412.

If the next highest ranking account is a debt account 416, the comparison module 107 (FIG. 1) determines whether one or some of the user's debt accounts requires a minimum payment 417. If none of the debt accounts require a minimum payment, then the contribution calculator 114 (FIG. 1) calculates the maximum monthly ranked account contribution for the debt accounts 418. If the maximum monthly ranked account contribution for the debt accounts is greater than zero, the allocation module 108 (FIG. 1) contributes the smaller amount of the following 424: maximum monthly ranked account contribution for the debt accounts; or remaining fund for the respective month.

If one or some of the user's debt accounts require a minimum payment and the maximum monthly ranked account contribution is greater than or equal to the remaining balance in one or some of the user's debt accounts 419, the debt accounts is paid in full 423. If the user cannot make all of the minimum payments, remaining money is allocated 420 via the allocation module 108 (FIG. 1) and the user is alerted to increase savings or implement other methods of remediation 422. For example, any remaining total monthly after tax savings amount can be allocated to pay the debt account. If there are additional ranked minimum payment accounts, the comparison module 107 (FIG. 1) resumes analyzing the remaining accounts in the list.

If there are no additional ranked minimum payment accounts 425 and the target safety net savings is less than three months of expenses, the application is directed to the safety net debt allocation step 427. The safety net debt allocation step verifies how much remaining fund remains each month and how much debt remains in the debt ranked accounts.

If the debt account is zero 428, the smaller of the following is allocated 429 to savings: 50% of the remaining fund for the respective month; or the target safety net savings. If the remaining fund is less than the remaining debt 430, then the smaller of the following is allocated to savings 432: 20% of the remaining fund for the respective month; or the target safety net savings. If the remaining debt is less than the remaining fund, the remaining debt is paid 433 and the smaller of the following is allocated 435 to savings; 50% of the remaining fund; or target safety net savings. If there are no additional ranked minimum payment accounts and there is sufficient target safety net savings, the allocation module 108 (FIG. 1) proceeds to the next ranked account.

If the next highest-ranking account is a college savings account 436, the comparison module 107 (FIG. 1) determines whether the amount contributed to college accounts is greater than or equal to the maximum monthly college contribution 437. If the amount contributed is greater than or equal to the maximum monthly college contribution, the comparison module 107 (FIG. 1) resumes analyzing the remaining accounts in the list. Otherwise, the comparison module 107 (FIG. 1) determines whether the total annual amount contributed to the college account is greater than or equal to the maximum annual ranked account contribution limit 438. If the amount is greater than or equal to the maximum annual ranked account contribution, the comparison module 107 (FIG. 1) resumes analyzing the remaining accounts.

If the total annual amount contributed to this account is not greater than or equal to the maximum annual ranked account contribution limit, the allocation module 108 (FIG. 1) contributes 440 to the account the smallest of the following: maximum monthly college contribution; maximum annual ranked contribution limit; maximum monthly ranked account contribution; or the remaining total monthly after tax savings amount for the respective month.

If the next highest-ranking account is an investment account 442, the user may allocate the remaining total monthly after tax savings amount for the respective month for investment 445. Alternatively, if the user does not have an investment account and the user has remaining funds 443, then all remaining funds is allocated to a savings account 446. It is contemplated that each time money is allocated to an account, the amount allocated is subtracted from the total monthly after tax savings amount. Once the remaining balance for allocation reaches $0, the allocation module 108 (FIG. 1) stops allocating 444 and alerts the user.

By allocating funds using the foregoing methods, the application can also predict the user's future net worth, wherein the future net worth is calculated by determining the sum of all of the funds in each of the user's accounts. The application also compares a user's financial portfolio to that of his or her peers. Without limitation, peer groups are identified using a variety of factors including age, income, location, number of dependents, home ownership status, and the like. Peer group comparisons can be used to determine whether or not a user is making the progress that he or she is expected to or recommended to make to retire or to meet other financial goals.

### A Scenario for Operation

The following may be considered a more concrete example of the functionality of the present system and method, as more generally shown in FIGS. 1 through 5F, in a realistic scenario involving a user.

Step 1: The user accesses the application 105 (FIG. 1) either as license or as an online subscription of a web offering such as a website, a web application, a mobile application, and the like.

Step 2: The application 105 (FIG. 1) collects the user's financial information (e.g., income, taxes, savings rate, financial accounts). The following methods are non-limiting examples of methods for receiving information relating to the users in the system: information relating to the user can be manually entered into the system by the user; and/or information relating to the user is automatically imported from third party sources such as financial institutions using an import tool.

Step 3: The ranking module analyzes the user's financial information to categorize each of the user's accounts into buckets by account type, and ranks the accounts by interest rate. An exemplary embodiment of the ranked accounts by interest rate only is shown below in Table 1.

TABLE 1

| Account | Interest Rate |
|---|---|
| Credit Card Minimum Payment | 100% |
| 401(k) Matched | 18.999% |
| Credit Card Stated | 18% |
| 401k Unmatched | 11.9999% |
| Investment | 6.999% |
| Brokerage | 5.4999% |
| Savings | 1% |

If two or more accounts comprise equal interest rates, the accounts are re-ranked based on the account type. If the account type is debt account, the debt accounts are ranked based on payment/account balances. An exemplary embodiment of the ranked accounts (i.e., established ranking order) is shown below in Table 2.

TABLE 2

| Account | Interest Rate | Payment/Balance |
|---|---|---|
| Credit Card 1 Minimum Payment | 100% | $150 minimum |
| | | payment |
| Credit Card 2 Minimum Payment | 100% | $18 minimum payment |
| 401(k) Matched | 18.999% | N/A |
| Credit Card Debt | 18% | $400 balance |
| Credit Card Debt | 18% | $2,750 balance |
| Student Loan Debt | 18% | $20,000 balance |
| Auto Loan Debt | 5% | N/A |

Step 4: The contribution calculator calculates monthly contribution amount for each of the accounts in each bucket based on the user's income, savings goal/rate, and taxes.

Step 5: The comparison module analyzes the monthly contribution amounts, contributions previously made, and account information in order to determine appropriate contribution amounts to allocate.

Step 6: The allocation module allocates money to each of the user's accounts until the monthly contribution amount has been exhausted or until allocation has been made to each of the buckets.

Step 7: The user's present assets and liabilities and protected assets and liabilities are used to calculate the user's present and future net worth over a period of time.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for saving money by making monthly contributions, comprising:
a memory unit having computer-executable instructions stored thereon, and a processor operatively connected to said memory unit, said processor configured to execute said instructions comprising:
obtain, by a web portal, a financial profile from a user, said financial profile comprising financial accounts associated with said user, wherein at least one of said financial accounts is a savings account;
categorize, by a ranking module, each of said financial accounts into buckets by account type, wherein each of said financial accounts comprises an interest rate;
rank, by said ranking module, each of said financial accounts, based on said interest rate in a descending order to produce a ranking list;
calculate, by a contribution calculator, a monthly contribution amount for each of said financial accounts, wherein said monthly contribution amount comprises a monthly savings contribution for said savings account; and
allocate, by an allocation module, said monthly contribution amount to each of said financial accounts in said buckets in accordance with said ranking list.

2. The system of claim 1, wherein said processor is further configured to execute said instructions comprising:
determine, by said ranking module, whether said interest rate of two or more of said financial accounts are equal;
identify, by said ranking module, said account type for each of said two or more of said financial accounts;
if said two or more of said financial accounts comprise a debt account, identify, by said ranking module, amount of payment due and remaining balance correlating to each of said two or more of said financial accounts;
modify, by said ranking module, said ranking list by re-ranking said debt account in descending order by amount of payment due and in ascending order by amount of remaining balance.

3. The system of claim 1, wherein said processor is further configured to execute said instructions comprising:
analyze, by a comparison module, said monthly contribution amount for each of said financial accounts to determine actual allocation amount for each of said financial accounts in said buckets, wherein said allocation module is configured to allocate said actual allocation amount if said actual allocation amount is not equal to said monthly contribution amount.

4. The system of claim 3, wherein said processor is further configured to execute said instructions comprising:
display on said buckets a sum of said actual allocation amount for each of said financial accounts within said buckets.

5. The system of claim 1, wherein said processor is further configured to execute said instructions comprising:
calculate, by said contribution calculator, a monthly savings amount based upon user inputs for savings rate, income, and taxes;
subtract, by said allocation module, said actual allocation amount from said monthly savings amount each time said actual allocation amount is disbursed to one of said financial accounts in said buckets.

6. The system of claim 1, wherein said processor is further configured to execute said instructions comprising:
calculate a present net worth and a future net worth of said user based on assets and liabilities derived from said financial accounts.

7. The system of claim 6, wherein said processor is further configured to execute said instructions comprising:
compare said present net worth and said future net worth of said user to a present net worth and a future net worth of a peer.

8. A system for saving money by making monthly contributions, comprising:
a processor;
a web portal comprising the functionality to:
obtain a financial profile from a user, said financial profile comprising financial accounts associated with said user, wherein at least one of said financial accounts is a savings account, further wherein said financial accounts are categorized into buckets by account type; and
display said buckets for each of said account type on a user interface;
a ranking module coupled to said web portal and executing on said processor, and comprising functionality to establish a ranking order for each of said financial accounts based on said account type and an interest rate associated with each of said financial accounts;
a contribution calculator coupled to said web portal and executing on said processor, and comprising functionality to calculate monthly contribution amount for each of said financial accounts, wherein said monthly contribution amount comprises a monthly savings contribution for said savings account; and
an allocation module coupled to said web portal and executing on said processor, and comprising functionality to allocate said monthly contribution amount in accordance with said ranking order.

9. The system of claim 8, further comprising a comparison module analyzing said monthly contribution amount for each of said financial accounts to determine actual allocation amount for each of said financial accounts in said buckets, wherein said allocation module is configured to allocate said actual allocation amount if said actual allocation amount is not equal to said monthly contribution amount.

10. The system of claim 9, wherein said buckets is configured to display a sum of said actual allocation amount for each of said financial accounts within said buckets.

11. The system of claim 8, wherein said buckets correspond to said account type and said buckets comprise a first bucket for said savings account, a second bucket for debt accounts, a third bucket for retirement accounts, a fourth bucket for investment accounts, a fifth bucket for college savings accounts, and a sixth bucket for mortgage accounts.

12. The system of claim 9, wherein said contribution calculator is further configured to calculate a monthly savings amount based upon user inputs for savings rate, income, and taxes; said allocation module further configured to subtract said actual allocation amount from said monthly savings amount each time said actual allocation amount is disbursed to one of said financial

13. A non-transitory computer-readable medium having computer-executable instructions for performing steps comprising:
receiving, by a web portal, a financial profile from a user, said financial profile comprising financial accounts associated with said user, wherein said financial accounts are categorized into buckets by account type;
generating, by said web portal, in a user interface comprising buckets for each of said account type;
calculating, by a contribution calculator, a monthly contribution amount for each of said financial accounts and a monthly savings amount based upon user inputs for savings rate, income, and taxes;
determining, by a comparison module, actual allocation amount for each of said financial accounts, wherein said actual allocation amount is disbursed to each of said financial accounts by an allocation module;
displaying, by said web portal, a sum of said actual allocation amounts for each of said financial accounts within said buckets;
displaying, by said web portal, in said user interface said sum of said actual allocation amounts for each of said buckets.

14. The medium of claim 13, further comprising computer-executable instructions for performing the step of:
displaying in said user interface present net worth and future net worth of said user.

15. The medium of claim 14, wherein said present net worth and said future net worth of said user is displayed in a graph.

16. The medium of claim 15, wherein said graph is configured to display an estimated net worth of said user corresponding to a specified time period when pinpointed at said specified time period with a cursor.

17. The medium of claim 13, further comprising computer-executable instructions for performing the step of:
displaying in said user interface monthly peer comparison and total peer comparison.

18. The medium of claim 13, wherein said allocation module is configured to disburse said actual allocation amounts in accordance with a ranking order established by a ranking module.
